(19) United States
(12) Patent Application Publication
(10) Pub. No.: US 2026/0138221 A1
(43) Pub. Date: May 21, 2026

(54) MANUAL WORKSTATION

(71) Applicant: Liebherr-Verzahntechnik GmbH, Kempten (DE)

(72) Inventors: Florian HOESSLE, Kempten (DE); Jan POLLMANN, Kempten (DE); Konrad BECHTELER, Kempten (DE); Christoph RAUH, Kempten (DE); Fabian BITTER, Kempten (DE)

(21) Appl. No.: 19/391,401

(22) Filed: Nov. 17, 2025

(30) Foreign Application Priority Data
Nov. 19, 2024 (DE) 10 2024 133 839.3

(51) Int. Cl. B23Q 1/54; B23Q 1/64; B23Q 11/08

(52) U.S. Cl. CPC B23Q 1/54; B23Q 1/64; B23Q 11/0891; B23Q 2707/00

(57) ABSTRACT

The present disclosure comprises a manual workstation for workpieces, comprising a manual workplace, a rotary table rotatable by means of a rotary axis, which is arranged at the manual workplace, wherein the rotary axis has a drive, a control unit for controlling the drive of the rotary axis, and operating elements for operating the manual workplace. It is provided that the operating elements comprise a first and a second operating arrangement, which are fixed in place and arranged separately from one another on the manual workstation, wherein the rotary axis is rotated in a first rotational direction by actuating the first operating arrangement and in a second, opposite rotational direction by actuating the second operating arrangement.

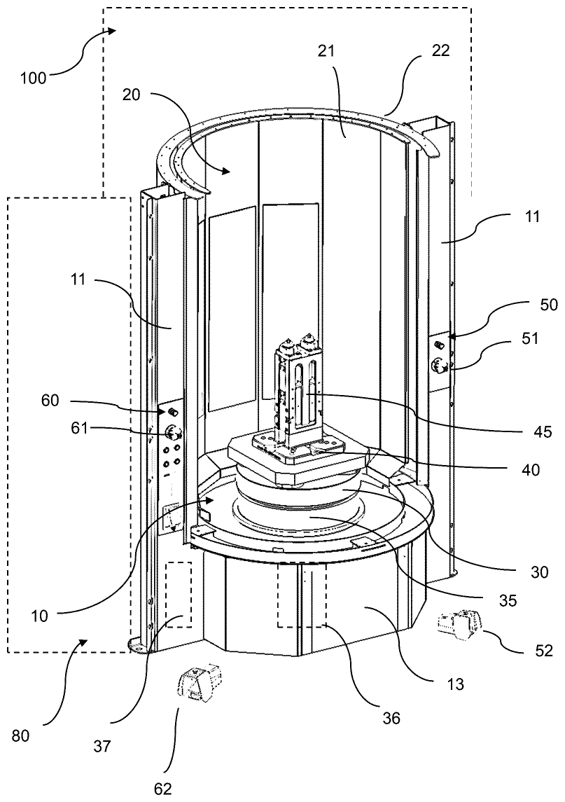

### CROSS REFERENCE TO RELATED APPLICATION

The present application claims priority to German Patent Application No. 10 2024 133 839.3 filed on Nov. 19, 2024. The entire contents of the above-listed application are hereby incorporated by reference for all purposes.

### TECHNICAL FIELD

The present disclosure relates to a manual workstation for workpieces, comprising a manual workplace and a rotary table rotatable by means of a rotary axis, which is arranged at the manual workplace, wherein the rotary axis comprises a drive.

### BACKGROUND

In particular, the manual workstation may be a loading station for transferring workpieces to a machine and/or automation system, in particular to a machining, transport and/or storage system.

### SUMMARY

Such a loading station is known, for example, from DE 20 2007 016 725 U1 and usually comprises a loading area for transferring the workpieces from a loading side to a machine side, which can be arranged in a safety fence of the machine system.

Such loading or setup areas serve to mount workpieces on pallets or workpiece carriers in order then to feed them into the safety area of the machine and/or automation system, for example of a machine tool, a robot cell, an automation cell or a pallet handling system. In order to ensure that safe work can be carried out at the setup area and that, during workpiece changeover, no one can enter the working area of the machine tool or the pallet handling system, the setup area is usually secured by a door system which releases access to the machine-side working area only after closing the loading-side door around the setup area.

In order to be able to reach the workpieces well from all sides during setup, a rotary table with a holder for the pallet or the workpiece carrier is often arranged at the setup area. For light workpieces and workpiece holders, the operator can rotate the pallet or the workpiece holder manually during setup in order to easily reach all sides of the workpiece. The rotation serves in particular to mount the workpiece on the pallet or the workpiece holder, to carry out measuring tasks, or to clean it before unclamping.

For very heavy workpieces, the rotation must be supported by a motor, since the effort required to rotate the workpiece would be too great for the operator. However, such motorized drive requires compliance with certain safety requirements so that the operator cannot be trapped between workpiece/pallet and the enclosure of the setup area when the rotary table is rotated by means of a drive motor. At the same time, however, the operator should be able to reach all sides of the workpiece as easily as possible and, if necessary, should also be able to carry out measuring tasks directly on the workpiece during rotation, such as a run-out test. The moving masses of workpiece, table, and machine plate can become very large. Therefore, certain safety criteria for the operation of this setup area must be observed so that the operator is not endangered during his work.

In order for the table in the setup area to comply with the currently valid safety regulations regarding hazardous movements, the relevant standards (usually DIN or DIN EN ISO) must be fulfilled. For example, certain minimum distances are regulated in order to avoid pinch points. By means of two-hand operation it can be prevented that the operator puts his limbs in danger. At the same time, however, it must be ensured that he can carry out his setup and measuring tasks. This results in partly contradictory requirements which must be considered and taken into account in a risk assessment.

In the prior art there are a large number of solutions to meet the safety requirements according to the risk assessment. For example, contact strips on the setup area enclosure can detect a possible crushing in time and stop the hazardous movement. Light barriers, scanners or cameras detect the movement of the operator in areas where hazards may occur and also stop the system. In addition, certain spacing dimensions may not be undercut in order to prevent dangerous crushing and shearing points.

Such safety elements are known, for example, from JP 2014 213431 A, EP 2 145 724 A2 and EP 1 306 603 A1.

Should there nevertheless be a risk of crushing, e.g. between the workpiece and the enclosure of the setup area, an immediate stop of the rotary movement of the table would be ideal if the actuation button of the control unit is released or if a collision between the operator and the enclosure of the setup area is detected. Due to the high mass inertia with large and heavy workpieces, high negative acceleration values are necessary so that the rotary movement can be stopped within a few mm, which would make the drive for the setup area table very complex and associated with high costs.

Similar problems also exist in general for manual workplaces with a rotary table.

The object of the present disclosure is therefore to provide an improved manual workstation. This object is achieved by a manual workstation as described herein.

The present disclosure comprises a manual workstation for workpieces with a manual workplace, a rotary table rotatable by means of a rotary axis, which is arranged at the manual workplace, wherein the rotary axis comprises a drive, a control unit for controlling the drive of the rotary axis, and operating elements for operating the manual workplace. The disclosure is characterized in that the operating elements comprise a first and a second operating arrangement, which are fixed in place and arranged separately from one another on the manual workstation, wherein the rotary axis is rotated in a first rotational direction by actuating the first operating arrangement and in a second, opposite rotational direction by actuating the second operating arrangement. The inventors have recognized that by using two separate operating arrangements and a rotational direction depending on the respective operating arrangement, the operating safety can be significantly increased.

According to a possible embodiment of the present disclosure, the first operating arrangement is arranged on a first side of the manual workplace and the second operating arrangement on a second side of the manual workplace. In this way it is ensured that the operating arrangements are arranged sufficiently far apart. In particular, the manual workplace and/or the rotary axis is arranged between the two operating arrangements.

According to a possible embodiment of the present disclosure, the first operating arrangement is arranged on the left side of the manual workplace and the second operating arrangement on the right side of the manual workplace, wherein the rotary axis is rotated counterclockwise by actuating the first operating arrangement and clockwise by actuating the second operating arrangement. In this way the rotary table is moved on the side on which the respective operating arrangement and thus the operator is located when operating the respective operating arrangement, towards the operator and/or from a machine side towards an operating side, so that body parts of the operator are prevented from being drawn into the manual workplace and/or crushed in the area of the manual workplace.

According to a possible embodiment of the present disclosure, no rotary movement in the second rotational direction can be triggered via the first operating arrangement and no rotary movement in the first rotational direction can be triggered via the second operating arrangement. This further increases safety.

According to a possible embodiment of the present disclosure, the manual workstation comprises an enclosure for the manual workplace. Optionally, this is arranged at least on one side of the manual workplace facing away from the operating side and surrounds the manual workplace on this side.

According to a possible embodiment of the present disclosure, the manual workstation is a loading station for transferring workpieces to a machine and/or automation system, for example to a machining, transport and/or storage system.

According to a possible embodiment of the present disclosure, the manual workplace is a loading area for transferring the workpieces from a loading side to a machine side of the loading area. In this case, the loading side is the operating side of the manual or loading area.

According to a possible embodiment of the present disclosure, the manual workstation comprises a door system for selectively separating the loading area from the loading side and the machine side. Optionally, the door system is designed in such a way that the machine side only opens when the loading side is closed, and vice versa. For example, the door system may be part of the enclosure of the manual workplace.

According to a possible embodiment of the present disclosure, the first operating arrangement and the second operating arrangement are in each case arranged at least partly in enclosure elements of the manual workstation arranged to the left and right of the manual workplace and/or door system. For example, these are stationary enclosure elements of the manual workstation. For example, at least one operating element of the respective operating arrangement is arranged in an enclosure element of the manual workstation arranged to the left or right of the manual workplace and/or door system. A further operating element may be designed as a foot pushbutton or foot switch and be arranged in the floor area.

The enclosure elements of the manual workstation can be integrated into a safety fence of the machine and/or automation system. The arrangement in the enclosure elements of the manual workstation ensures that the operator, when operating the respective operating arrangement, actually stands on the side on which the operating arrangement is arranged.

According to a possible embodiment of the present disclosure, the first and the second operating arrangement each comprise an enabling device and a directional control or a two-hand control for controlling the rotary movement of the rotary axis. This further increases safety. For example, the directional control can only be actuated if the enabling device is also actuated. The directional control can be used to set the orientation of the rotary table. This comprises, for example, a rotary knob which the rotary table follows in its orientation, or a hand or foot pushbutton via which a rotary movement is triggered. As described above, however, only a rotary movement in the direction provided according to the disclosure is possible or specifiable. In particular, the directional control is designed as a hand or foot pushbutton or a hand or foot switch, wherein for example a hand-operated enabling device and a foot pushbutton as directional control are provided.

According to an alternative embodiment, however, only one directional control may be provided in each case, for example in the form of a hand switch or hand pushbutton, without an enabling device being used.

According to a possible embodiment of the present disclosure, the manual workplace is a setup area, wherein one or more workpieces can optionally be arranged on the rotary table on one or more workpiece carriers and/or pallets. For example, the rotary table therefore comprises a holder on which one or more workpiece carriers and/or pallets can be arranged.

The drive of the rotary axis may be a pneumatic, hydraulic and/or electric drive.

The rotary axis is optionally aligned vertically and rotates the rotary table about a vertical axis of rotation.

However, the rotary axis may also be any other rotary axis. For example, the rotary axis may also be a swivel axis.

The present disclosure further comprises a safety fence with a manual workstation as described above. For example, the manual workstation may be integrated into the safety fence.

The present disclosure further comprises a machine system with a safety fence and/or a manual workstation as described above.

The machine and/or automation system may for example be a machine tool and/or a robot cell and/or an automation cell and/or a pallet handling system.

Optionally, the machine system, the safety fence and/or the manual workstation are designed as already described above.

The present disclosure will now be described in more detail with reference to an exemplary embodiment and a drawing.

### BRIEF DESCRIPTION OF THE FIGURE

In the drawing:

The FIGURE shows an exemplary embodiment of a manual workstation according to the disclosure.

### DETAILED DESCRIPTION

The manual workstation shown in the exemplary embodiment comprises a manual workplace 10, for example a loading and/or setup area, at which a rotary table 30 rotatable by means of a vertical rotary axis 35 is provided.

The rotary table 30 comprises a holder for a workpiece carrier 40 and/or a pallet on which a workpiece 45 is arranged.

The rotary axis is actuated via a schematically illustrated drive 36, which is controlled via a control unit 37. The control unit 37 is connected to operating elements 50, 60 and is operated via them.

The manual workplace comprises, in the exemplary embodiment, an enclosure or housing 20, which surrounds it at least on the side facing away from the operating side.

According to the disclosure, the idea now consists in preventing a hazardous movement from occurring at all, by designing the rotational direction of the rotary table 30 according to the position of the operator so that no risk of drawing-in and/or crushing between workpiece, pallet and manual workplace housing can occur.

The table rotation is triggered, depending on the operator's position at the manual workplace, only clockwise or counterclockwise. The workpiece can then only rotate in such a way that on the side of the manual workplace on which the operator is standing, there is no risk of drawing-in between workpiece and setup area enclosure. The workpiece therefore always rotates away from a possible pinch point.

This also ensures for large and heavy workpieces that the stopping distance of the workpiece rotation is sufficiently short without the braking system or the drive train having to be dimensioned too large and therefore too expensive. This is achieved by integrating two separate operating units 60, 50 to the left and right of the manual workplace 10 into the housing 11, and the rotational direction for the table 40 is predetermined depending on the position of the operating unit 60, 50.

The costs for the two separate operating units 60, 50 are significantly lower than those for a complex braking system or a complex drive train possibly coupled with contact strips or light barriers as frequently used in the prior art. Of course, however, the present disclosure can also be combined with such further safety elements as contact strips or light barriers to further increase safety.

The operating concept, which can be used not only for a setup area as described above, but in general for any manual workplace with a rotary axis, can therefore be summarized as follows:
Two operating stations 50, 60 are provided, which are fixed in place and arranged separately from one another on the manual workplace. Via each operating station 50, 60, the rotary axis can only be moved in one rotational direction.

Each operating station has, in the exemplary embodiment, an enabling device 51, 61 and a directional control 52, 62. In the exemplary embodiment, the directional control is effected by the foot pushbuttons 52, 62, so that one hand remains free for e.g. measuring work. The enabling device 51, 61 is in each case a hand-operated pushbutton, which is mounted in the enclosure elements 11 arranged to the right and left of the manual workplace. In addition to the enabling devices 51, 61, emergency stop switches are also provided there.

Alternatively, the actuation of the rotary axis can also be effected via a two-hand control mounted to the right and left of the manual workplace in the enclosure element 11 for actuating the rotary axis.

Alternatively, the directional control can also be effected via hand pushbuttons at the operating stations, without an enabling device being provided for this purpose.

The operating elements for the enabling device and directional control, or the operating elements of the two-hand control, or the hand pushbuttons are fixed in place.

The operating elements of the two operating stations are arranged spatially separated from one another. For example, the arrangement is made in such a way that an operator who actuates one operating station cannot reach the other operating station from the position taken for this purpose.

In a manual workstation, as shown for example in the FIGURE, in which the rotary axis runs vertically and the two operating stations or operating arrangements 50, 60 are arranged to the right and left of the manual workplace 10, the control can be as follows:
Operating station 60 (arranged on the left): By actuating the enabling device 61 and directional control 62 or by actuating the two-hand control, the rotary axis 35 rotates exclusively counterclockwise.
Operating station 50 (arranged on the right): By actuating the enabling device 51 and directional control 52 or by actuating the two-hand control, the rotary axis 35 rotates exclusively clockwise.

The advantage of the new operating concept is that by limiting the rotational direction the probability of crushing, shearing as well as drawing-in of the operator is reduced.

This is particularly the case in processes where the operator must be in the immediate vicinity of the rotary axis (e.g. for cleaning the workpiece or performing measurements). The safety for the operator is thus increased.

The disclosure relates in general to manual workplaces with power-driven rotary or swivel axes (electric, hydraulic or pneumatic). In particular, it can be used in a setup area for machine tools and automation systems. It protects an operator, for example, when separating protective devices are open or non-separating protective devices are disabled.

As shown in the FIGURE, the manual workplace 10 can be arranged on a pedestal 13. The drive 35 for the rotary axis 35 can also be arranged therein.

Furthermore, stationary enclosure elements 11 are provided to the right and left of the manual workplace 10, with which the manual workplace can optionally be integrated into a safety fence 80.

The enclosure 20 can comprise a door system which, in the position shown in the FIGURE, closes the manual workplace on its rear machine side. In a second position, not shown, the door system can close the operating or loading side, so that the machine side can be opened. The workpiece can then be removed by automation from the machine side from the handling space.

The manual workstation can be used as a loading station for a machine and/or automation system 100, which is surrounded by a safety fence 80, the loading station allowing workpieces to be brought into or removed from the area of the machine system.

In the exemplary embodiment, the door system for this purpose comprises a first door element 21 and a second door element 22, which are arranged on the pedestal 13 so as to be displaceable along the circumference of the manual workplace and each close a circumference of at least 180°. For example, the door system and/or the manual workstation can be designed as known from document DE 20 2007 016 725 U1.

However, the present disclosure can also be used with differently designed manual workstations and differently designed loading stations.

1. A manual workstation for workpieces, comprising:
a manual workplace,
a rotary table rotatable by means of a rotary axis, which is arranged at the manual workplace, wherein the rotary axis comprises a drive,
a control unit for controlling the drive of the rotary axis, and
operating elements for operating the manual workplace,
wherein the operating elements comprise a first operating arrangement and a second operating arrangement, which are fixed in place and arranged separately from one another on the manual workstation, wherein the rotary axis is rotated in a first rotational direction by actuating the first operating arrangement and in a second, opposite rotational direction by actuating the second operating arrangement.

2. The manual workstation according to claim 1, wherein the first operating arrangement is arranged on a first side of the manual workplace and the second operating arrangement on a second side of the manual workplace.

3. The manual workstation according to claim 1, wherein no rotary movement in the second rotational direction can be triggered via the first operating arrangement and no rotary movement in the first rotational direction can be triggered via the second operating arrangement.

4. The manual workstation according to claim 1, further comprising an enclosure for the manual workplace.

5. The manual workstation according to claim 1, wherein the manual workstation is a loading station for transferring workpieces to a machine and/or automation system, and wherein the manual workplace is a loading area for transferring the workpieces from a loading side to a machine side of the loading area.

6. The manual workstation according to claim 5, further comprising a door system for selectively separating the manual workplace from the loading side and the machine side.

7. The manual workstation according to claim 5, wherein at least one operating element of the first operating arrangement and of the second operating arrangement is arranged in enclosure elements of the loading station arranged to the left and right of the manual workplace and/or a door system.

8. The manual workstation according to claim 1, wherein the first operating arrangement and the second operating arrangement each comprise an enabling device and a directional control, or a two-hand control for controlling rotary movement of the rotary axis.

9. The manual workstation according to claim 1, wherein the first operating arrangement and the second operating arrangement each comprise a hand-operated enabling device and a foot pushbutton as directional control.

10. The manual workstation according to claim 1, wherein the manual workplace is a setup area.

11. A safety fence with the manual workstation according to claim 1.

12. A machine system with the manual workstation according to claim 1.

13. The machine system according to claim 12, wherein the manual workstation is a loading station for transferring workpieces to a machine and/or automation system, and wherein the machine and/or automation system is a machine tool, a robot cell, an automation cell and/or a pallet handling system.

14. The manual workstation according to claim 2, wherein the first operating arrangement is arranged on a left side of the manual workplace and the second operating arrangement is arranged on a right side of the manual workplace, and the rotary axis is rotated counterclockwise by actuating the first operating arrangement and the rotary axis is rotated clockwise by actuating the second operating arrangement.

15. The manual workstation according to claim 5, wherein the machine and/or automation system is a machining, transport and/or storage system.

16. The manual workstation according to claim 6, wherein the door system is designed in such a way that the machine side only opens when the loading side is closed, and vice versa.

17. The manual workstation according to claim 8, wherein the directional control is designed as a hand or foot pushbutton or a hand or foot switch.

18. The manual workstation according to claim 10, further comprising one or more workpiece carriers and/or pallets, wherein one or more workpieces can be arranged on the rotary table on the one or more workpiece carriers and/or pallets.
